(19) United States
(12) Patent Application Publication
(10) Pub. No.: US 2023/0005666 A1
(43) Pub. Date: Jan. 5, 2023

(54) CAPACITORS ENCAPSULATED WITH AT LEAST ONE POLYMER HAVING HIGH THERMAL STABILITY

(71) Applicant: W. L. Gore & Associates, Inc., Newark, DE (US)

(72) Inventors: Luis Emmanuelli, Newark, DE (US); Thomas Cooper, Newark, DE (US); Robert Bell, Newark, DE (US); Venkateswaran Santhanam, Newark, DE (US)

(21) Appl. No.: 17/782,511

(22) PCT Filed: Dec. 4, 2019
(86) PCT No.: PCT/US2019/064530

§ 371 Date: Jun. 3, 2022

(51) Int. Cl. H01G 4/224

(52) U.S. Cl. CPC H01G 4/224

(57) ABSTRACT

Some embodiments of the present disclosure relate to a device comprising: a capacitor and at least one encapsulant. In some embodiments, the at least one encapsulant comprises at least one polymer. In some embodiments, the at least one encapsulant at least partially encapsulates the capacitor. In some embodiments, the at least one encapsulant has a stable Young's modulus. Some embodiments of the present disclosure further relate to methods of manufacturing and using the device described herein. In the examples the at least one polymer is a PVDF.

### CROSS-REFERENCE TO RELATED APPLICATION

This application is a national phase application of PCT Application No. PCT/US2019/064530, internationally filed on Dec. 4, 2019, which is herein incorporated by reference in its entirety for all purposes.

### FIELD

The present disclosure relates to capacitors encapsulated with at least one polymer having high thermal stability.

### BACKGROUND

Many capacitors have limitations that prevent their widespread adoption. One specific issue is the ability of a capacitor to retain performance under high temperatures. Other conditions such as low temperatures, moisture, and thermal stress may also affect capacitor performance. Improved technologies relating to capacitor performance are therefore needed.

### SUMMARY

Covered embodiments are defined by the claims, not this summary. This summary is a high-level overview of various aspects and introduces some of the concepts that are further described in the Detailed Description section below. This summary is not intended to identify key or essential features of the claimed subject matter, nor is it intended to be used in isolation to determine the scope of the claimed subject matter. The subject matter should be understood by reference to appropriate portions of the entire specification, any or all drawings, and each claim.

Some embodiments of the present disclosure relate to a device comprising: a capacitor; and at least one encapsulant, wherein the at least one encapsulant comprises at least one polymer;

wherein the at least one encapsulant at least partially encapsulates the capacitor; wherein the at least one encapsulant has a stable Young's modulus, and wherein the stable Young's modulus is a Young's modulus that ranges from 0.001 GPa to 5.5 GPa at temperatures ranging from −55° C. to 150° C. measured at 0.07% strain before, during, and after the device is subjected to at least 500 thermal cycles.

In some embodiments, the at least one encapsulant has a stable yield strain, wherein the stable yield strain is a minimum maintained yield strain of the at least one encapsulant before, during, and after the device is subjected to at least 500 thermal cycles; wherein the stable yield strain exceeds 2.5% at a yield stress exceeding 30 MPa at −55° C.; and wherein the stable yield strain exceeds 3.5% at a yield stress exceeding 0.25 MPa at 150° C.

In some embodiments, the stable yield strain ranges from 2.5% to 100% at a yield stress ranging from 30 MPa to 5500 MPa at −55° C.

In some embodiments, the stable yield strain ranges from 3.5% to 100% at a yield stress ranging from 0.25 MPa to 5500 MPa at 150° C.

In some embodiments, at least one of the: stable Young's modulus or the stable yield strain is maintained before, during, and after the device is subjected to from 500 to thermal cycles.

In some embodiments, the at least one encapsulant has a thickness of from 0.05 mm to 20 mm.

In some embodiments, the capacitor is a film capacitor.

In some embodiments, the capacitor further comprises: a first electrode; a second electrode; and at least one dielectric layer, wherein the at least one dielectric layer is disposed between the first electrode of the capacitor and the second electrode of the capacitor.

In some embodiments, the capacitor further comprises: a first end, wherein the first electrode is at the first end of the capacitor; a second end, wherein the second electrode is at the second end of the capacitor; a first dielectric layer, wherein the first dielectric layer is disposed between the first electrode and the second electrode, wherein the first electrode has an exposed surface opposite to the first dielectric layer; and a second dielectric layer.

In some embodiments, the at least one encapsulant is disposed on at least one of: the first end of the capacitor or the second end of the capacitor.

In some embodiments, the capacitor comprises a polytetrafluoroethylene (PTFE) film.

In some embodiments, the capacitor is chosen from: an electrolytic capacitor, a ceramic capacitor, a mica capacitor, or a paper capacitor.

In some embodiments, at least one polymer of the at least one encapsulant comprises at least one thermoplastic elastomer (TPE).

In some embodiments, the at least one TPE comprises at least one polymer chosen from: at least one polystyrene (PS), at least one polyolefin (PO), at least one polyether imide (PEI), at least one polyurethane (PU), at least one polyester (PE), at least one polyamide (PA), or any combination thereof.

In some embodiments, the at least one polymer of the at least one encapsulant comprises at least one thermoset elastomer (TE).

In some embodiments, the at least one TE comprises at least one epoxy resin, at least one fluorosilicone rubber, or any combination, mixture or copolymer thereof.

In some embodiments, the at least one polymer of the at least one encapsulant is chosen from: at least one vinylidene fluoride homopolymer, at least one vinylidene fluoride copolymer, or any combination thereof.

In some embodiments, the at least one vinylidene fluoride copolymer is at least one copolymer of hexafluoropropylene and vinylidene fluoride.

In some embodiments, the capacitor is a stacked capacitor.

In some embodiments, the capacitor is a wound capacitor.

In some embodiments, the capacitor has a capacitance of 0.1 μF to 2000 μF.

In some embodiments, the capacitor has a capacitance ranging from 10 μF to 50 μF.

In some embodiments, the at least one dielectric layer has a thickness of 1 micron to 6 microns.

In some embodiments, the at least one encapsulant partially encapsulates the capacitor.

Some embodiments of the present disclosure relate to a device comprising: a capacitor; at least one encapsulant, wherein the at least one encapsulant comprises at least one polymer; wherein the at least one polymer is chosen from: at least one vinylidene fluoride homopolymer, at least one vinylidene fluoride copolymer, or any combination thereof; wherein the at least one encapsulant fully encapsulates the capacitor; wherein the at least one encapsulant has: a thickness ranging from 0.05 mm to 20 mm; and a stable Young's modulus, wherein the stable Young's modulus is a Young's modulus that ranges from 0.001 GPa to 5.5 GPa at a temperature from −55° C. to 150° C. measured at 0.07% strain before, during, and after the device is subjected to at least 500 thermal cycles.

Some embodiments of the present disclosure relate to a method comprising: applying at least one encapsulant to at least one portion of a capacitor, so as to at least partially encapsulate the capacitor, thereby forming a device comprising the capacitor and the at the least one encapsulant; wherein the encapsulant at least partially encapsulates the capacitor; wherein the at least one encapsulant comprises at least one polymer; wherein the at least one encapsulant has a stable Young's modulus, wherein the stable Young's modulus is a Young's modulus that ranges from 0.001 GPa to 5.5 GPa at temperatures from −55° C. to 150° C. measured at 0.07% strain before, during, and after the device is subjected to at least 500 thermal cycles.

In some embodiments, the at least one encapsulant has a stable yield strain, wherein the stable yield strain is a minimum maintained yield strain of the at least one encapsulant before, during, and after the device is subjected to at least 500 thermal cycles; wherein the stable yield strain exceeds 2.5% at a yield stress exceeding 30 MPa at −55° C.; and wherein the stable yield strain exceeds 3.5% at a yield stress exceeding 0.25 MPa at 150° C.

In some embodiments, the applying step comprises spray coating a solution comprising the at least one encapsulant on at least a portion of the capacitor, so as to partially encapsulate the capacitor.

In some embodiments, the spray coating coats the at least one encapsulant into one or more voids on the capacitor.

In some embodiments, the at least one encapsulant is applied to: a first end of the capacitor, a second end of the capacitor, or any combination thereof.

In some embodiments, the applying step comprises dipping at least a portion of the capacitor into a solution comprising the at least one encapsulant, so as to partially encapsulate the capacitor.

In some embodiments, the solution comprises a solvent chosen from: N-Methyl-2-Pyrrolidone; N, N-dimethylacetamide; N, N-dimethylformamide; N, N-dimethylacetamide; hexamethylphosphoramide; tetramethylurea; triethylphosphate trimethylphosphate, or any combination thereof.

In some embodiments, the method further comprises evaporating the at least one solvent.

In some embodiments, the applying step comprises injection molding the at least one encapsulant over the capacitor, so as to fully encapsulate the capacitor.

In some embodiments, the at least one encapsulant has a thickness of 0.05 mm to 20 mm after the applying step.

Some embodiments of the present disclosure relate to a method comprising: providing a device comprising: a capacitor; and at least one encapsulant, wherein the at least one encapsulant comprises at least one polymer; wherein the at least one encapsulant at least partially encapsulates the capacitor; subjecting the device to at least thermal cycles; wherein, before, during, and after the subjecting step, the device has a stable Young's modulus, wherein the stable Young's modulus is a Young's modulus that ranges from 0.001 GPa to 5.5 GPa at temperatures from −55° C. to 150° C. measured at 0.07% strain.

In some embodiments, after the subjecting step, the at least one encapsulant has a stable yield strain, wherein the stable yield strain is a minimum maintained yield strain of the at least one encapsulant before, during, and after the subjecting step; wherein the stable yield strain exceeds 2.5% at a yield stress exceeding 30 MPa at −55° C.; and wherein the stable yield strain exceeds 3.5% at a yield stress exceeding 0.25 MPa at 150° C.

In some embodiments, the device is subjected to 500 to 1000 thermal cycles during the subjecting step.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 depicts a non-limiting example of a film capacitor according to the present disclosure.

FIG. 2 depicts exemplary dynamic mechanical analysis (DMA) data for certain exemplary polymers according to the present disclosure.

FIG. 3 depicts exemplary differential scanning calorimetry (DSC) data for certain exemplary polymers according to the present disclosure.

FIG. 4 depicts stress-strain data for certain exemplary polymers according to the present disclosure.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

All prior patents, publications, and test methods referenced herein are incorporated by reference in their entireties.

As used herein, the term “fully encapsulates” is defined as “covering the entire surface area of a capacitor.”

As used herein, the term “partially encapsulates” is defined as “covering less the entire surface area of a capacitor.” A non-limiting example of partial encapsulation is the covering of ends (e.g., the first and end and the second end described herein, infra) of a capacitor.

As used herein, the term “at least partially encapsulates” is defined as “covering some or all of the surface area of the capacitor.” Put differently, “at least partially encapsulates” includes both partial and full encapsulation.

As used herein, the term “encapsulates” includes all degrees of encapsulation, including but not limited to, partial encapsulation and full encapsulation.

As used herein an “encapsulant” is a substance that is capable of encapsulating a capacitor.

As used herein, a “thermal cycle” is defined as taking a device from room temperature to a first temperature below room temperature (e.g., in some non-limiting embodiments, −55° C.), back to room temperature, then to a second temperature above room temperature (e.g., in some non-limiting embodiments, 150° C.), and then back to room temperature.

As used herein, a “stable Young's modulus” of an encapsulant is a Young's modulus that ranges from 0.001 GPa to 5.5 GPa at temperatures ranging from −55° C. to 150° C. measured at 0.07% strain before, during, after a device comprising the encapsulant is subjected to multiple thermal cycles. In some embodiments, the “stable Young's modulus” is measured using dynamic mechanical analysis (“DMA”).

As used herein, “minimum maintained yield strain” is a yield strain that stays above a minimum point of a stated yield strain range before, during, and after a stated thermal cycling range.

As used herein, a “stable yield strain” is the minimum maintained yield strain of an encapsulant before, during, and after a device comprising the encapsulant is subjected to multiple thermal cycles.

As used herein, the term “void” refers to a porous portion of a material having a porosity. In some non-limiting embodiments, one or more voids may be located on a first end of any capacitor described herein, on a second end of any capacitor described herein, or any combination thereof.

As used herein, the term “nominal” means that a specific quantity (e.g., thickness, capacitance) was not measured, but was instead inspected by a skilled artisan and confirmed to have a value that would be within a reasonable margin of error (e.g., ±5%, ±10%) of the value of the same quantity, had the quantity been measured.

Some embodiments of the present disclosure relate to a device.

In some embodiments, the device comprises a capacitor. In some non-limiting exemplary embodiments, the device that comprises the capacitor is a motor, a coupler, a decoupler, an amplifier, a filter, an oscillator, a circuit, or any combination thereof. In some embodiments, the device is the capacitor itself.

In some embodiments, the capacitor is chosen from: an electrolytic capacitor, a ceramic capacitor, a mica capacitor, or a paper capacitor.

In some embodiments, the capacitor is a film capacitor. In some embodiments, the film capacitor comprises a first electrode. In some embodiments, the film capacitor further comprises a first end. In some embodiments, the first electrode is at the first end of the film capacitor. In some embodiments, the film capacitor comprises a second electrode. In some embodiments, the film capacitor comprises a second end. In some embodiments, the second electrode is at the second end of the film capacitor. In some embodiments, the film capacitor comprises at least one dielectric layer. In some embodiments, the at least one dielectric layer is disposed between the first electrode and the second electrode.

In some embodiments, the film capacitor comprises a first dielectric layer and a second dielectric layer. In some embodiments, the first dielectric layer is disposed between the first electrode and the second electrode. In some embodiments, the first electrode has an exposed surface opposite to the first dielectric layer.

In some embodiments, the at least one dielectric layer has a thickness of 1 micron to 6 microns. In some embodiments, the at least one dielectric layer has a thickness of 1 micron to 5 microns. In some embodiments, the at least one dielectric layer has a thickness of 1 micron to 4 microns. In some embodiments, the at least one dielectric layer has a thickness of 1 micron to 3 microns. In some embodiments, the at least one dielectric layer has a thickness of 1 micron to 2 microns.

In some embodiments, the at least one dielectric layer has a thickness of 2 microns to 6 microns. In some embodiments, the at least one dielectric layer has a thickness of 3 microns to 6 microns. In some embodiments, the at least one dielectric layer has a thickness of 4 microns to 6 microns. In some embodiments, the at least one dielectric layer has a thickness of 5 microns to 6 microns.

In some embodiments, the at least one dielectric layer has a thickness of 2 microns to 5 microns. In some embodiments, the at least one dielectric layer has a thickness of 3 microns to 4 microns.

In some embodiments, the capacitor comprises a polytetrafluoroethylene (PTFE) film. In some embodiments, the at least one dielectric layer of the capacitor comprises the PTFE film. In some embodiments, the PTFE film is an expanded PTFE (ePTFE) film. In some embodiments, the ePTFE film is a densified ePTFE film.

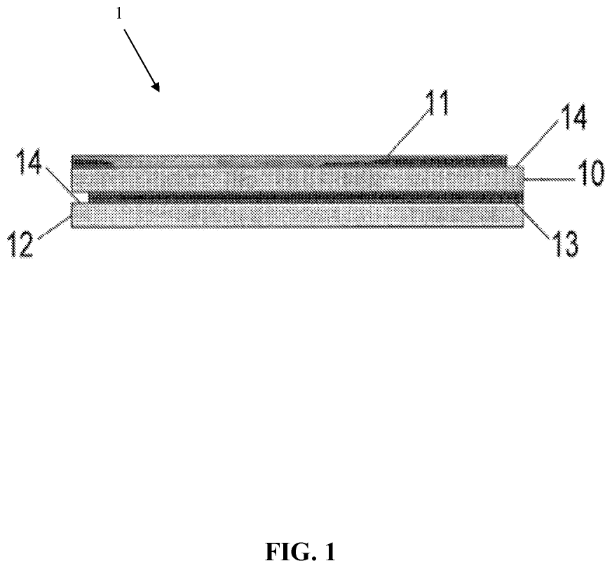

A non-limiting example of a film capacitor according to the present disclosure is shown in FIG. 1. As shown, in some embodiments, an illustrative film capacitor 1 may include a first dielectric layer 10 disposed on a first electrode 11. In some embodiments, the first electrode 11 is an anode. In some embodiments, a second dielectric layer 12 is disposed on a second electrode 13. In some embodiments, the second electrode 13 is a cathode. In some embodiments, the film capacitor 1 can include one or more regions 14 containing one or more voids (not shown). The one or more void-containing regions 14 may be disposed at a first end of the film capacitor 1, a second end of the film capacitor 1, or any combination thereof. Additional details regarding the film capacitor of Example 1, as well as further exemplary embodiments of film capacitors within the scope of the present disclosure, can be found in U.S. Pat. No. 9,384,895, which is incorporated by reference herein in entirety.

In some embodiments, the capacitor is a stacked capacitor. In some embodiments, the capacitor is a wound capacitor.

In some embodiments, the capacitor has a capacitance of 0.1 μF to 2000 μF. In some embodiments, the capacitor has a capacitance of 0.1 μF to 1000 μF. In some embodiments, the capacitor has a capacitance of 0.1 μF to 500 μF. In some embodiments, the capacitor has a capacitance of 0.1 μF to 100 μF. In some embodiments, the capacitor has a capacitance of 0.1 μF to 50 μF. In some embodiments, the capacitor has a capacitance of 0.1 μF to 10 μF. In some embodiments, the capacitor has a capacitance of 0.1 μF to 5 μF. In some embodiments, the capacitor has a capacitance of 0.1 μF to 1 μF. In some embodiments, the capacitor has a capacitance of 0.1 μF to 0.5 μF.

In some embodiments, the capacitor has a capacitance of 0.5 μF to 2000 μF. In some embodiments, the capacitor has a capacitance of 1 μF to 2000 μF. In some embodiments, the capacitor has a capacitance of 10 μF to 2000 μF. In some embodiments, the capacitor has a capacitance of 50 μF to 2000 μF. In some embodiments, the capacitor has a capacitance of 100 μF to 2000 μF. In some embodiments, the capacitor has a capacitance of 500 μF to 2000 μF. In some embodiments, the capacitor has a capacitance of 1000 μF to 2000 μF.

In some embodiments, the capacitor has a capacitance of 0.1 μF to 1000 μF. In some embodiments, the capacitor has a capacitance of 1 μF to 500 μF. In some embodiments, the capacitor has a capacitance ranging from 10 μF to 50 μF. In some embodiments, the capacitor has a capacitance ranging from 20 μF to 40 μF. In some embodiments, the capacitor has a capacitance ranging from 25 μF to 30 μF.

In some embodiments, the device comprises at least one encapsulant.

In some embodiments, the at least one encapsulant comprises at least one polymer.

In some embodiments, the at least one polymer of the at least one encapsulant comprises at least one thermoplastic elastomer (TPE). In some embodiments, the at least one TPE comprises at least one polymer chosen from: at least one polystyrene (PS), at least one polyolefin (PO), at least one polyether imide (PEI), at least one polyurethane (PU), at least one polyester (PE), at least one polyamide (PA), or any combination thereof. In some embodiments, the at least one TPE is selected from the group consisting of: at least one polystyrene (PS), at least one polyolefin (PO), at least one polyether imide (PEI), at least one polyurethane (PU), at least one polyester (PE), at least one polyamide (PA), and any combination thereof.

In some embodiments, the at least one polymer of the at least one encapsulant comprises at least one thermoset elastomer (TE). In some embodiments, the TE comprises at least one epoxy resin, at least one fluorosilicone rubber, or any combination, mixture, or copolymer thereof. A non-limiting, commercially available illustrative example of the at least one fluorosilicone rubber is Silastic® FL 60-9201 F-LSR from Dow Corning®.

In some embodiments, the at least one polymer of the at least one encapsulant is chosen from: at least one vinylidene fluoride homopolymer, at least one vinylidene fluoride copolymer, or any combination thereof. In some embodiments, the at least one polymer of the at least one encapsulant is selected from the group consisting of: at least one vinylidene fluoride homopolymer, at least one vinylidene fluoride copolymer, or any combination thereof. In some embodiments, the at least one vinylidene fluoride copolymer is at least one copolymer of hexafluoropropylene and vinylidene fluoride. A commercially available non-limiting example of the at least one copolymer of hexafluoropropylene and vinylidene fluoride is Kynar Flex® 3030-10 from Arkema.

In some embodiments, the at least one encapsulant at least partially encapsulates the capacitor. In some embodiments, the at least one encapsulant partially encapsulates the capacitor. In some embodiments, the at least one encapsulant fully encapsulates the capacitor. In some embodiments, such as embodiments where the capacitor is a film capacitor, the at least one encapsulant partially encapsulates at least one of: the first end of the film capacitor, the second end of the film capacitor, or any combination thereof. In some embodiments, the at least one encapsulant partially encapsulates at least one of: one or more voids on the first end of the film capacitor, one or more voids on the second end of the film capacitor, or any combination thereof.

In some embodiments, the at least one encapsulant has a thickness ranging from 0.05 to 20 mm. In some embodiments, the at least one encapsulant has a thickness ranging from 0.05 to 10 mm. In some embodiments, the at least one encapsulant has a thickness ranging from 0.05 to 5 mm. In some embodiments, the at least one encapsulant has a thickness ranging from 0.05 mm to 4 mm. In some embodiments, the at least one encapsulant has a thickness ranging from 0.05 mm to 3 mm. In some embodiments, the at least one encapsulant has a thickness ranging from 0.05 mm to 2 mm. In some embodiments, the at least one encapsulant has a thickness ranging from 0.05 mm to 1 mm. In some embodiments, the at least one encapsulant has a thickness ranging from 0.05 mm to 0.5 mm. In some embodiments, the at least one encapsulant has a thickness ranging from 0.05 mm to 0.1 mm.

In some embodiments, the at least one encapsulant has a thickness ranging from 0.1 mm to 20 mm. In some embodiments, the at least one encapsulant has a thickness ranging from 0.5 mm to 20 mm. In some embodiments, the at least one encapsulant has a thickness ranging from 1 mm to 20 mm. In some embodiments, the at least one encapsulant has a thickness ranging from 2 mm to 20 mm. In some embodiments, the at least one encapsulant has a thickness ranging from 3 mm to 20 mm. In some embodiments, the at least one encapsulant has a thickness ranging from 4 mm to 20 mm. In some embodiments, the at least one encapsulant has a thickness ranging from 5 mm to 20 mm.

In some embodiments, the at least one encapsulant has a thickness ranging from 0.1 mm to 10 mm. In some embodiments, the at least one encapsulant has a thickness ranging from 1 mm to 5 mm. In some embodiments, the at least one encapsulant has a thickness ranging from 2 mm to 3 mm.

In some embodiments, the at least one encapsulant has a thickness ranging from 0.1 mm to 4 mm. In some embodiments, the at least one encapsulant has a thickness ranging from 0.1 mm to 3 mm. In some embodiments, the at least one encapsulant has a thickness ranging from 0.1 mm to 2 mm. In some embodiments, the at least one encapsulant has thickness ranging from 0.1 mm to 1 mm. In some embodiments, the at least one encapsulant has a thickness ranging from 0.1 mm to 0.5 mm.

In some embodiments, the at least one encapsulant has a thickness ranging from 0.5 mm to 4 mm. In some embodiments, the at least one encapsulant has a thickness ranging from 1 mm to 4 mm. In some embodiments, the at least one encapsulant has a thickness ranging from 2 mm to 4 mm. In some embodiments the at least one encapsulant has a thickness ranging from 3 mm to 4 mm.

In some embodiments, the at least one encapsulant has a stable Young's modulus, as defined herein, supra.

In some embodiments the stable Young's modulus is stable at a range of from 0.001 GPa to 5.5 GPa at temperatures ranging from −55° C. to 150° C. measured at 0.07% strain before, during, and after the device is subjected to at least 500 thermal cycles. In some embodiments the stable Young's modulus is stable at a range of from 0.01 GPa to 4 GPa at temperatures ranging from −55° C. to 150° C. measured at 0.07% strain before, during, and after the device is subjected to at least 500 thermal cycles. In some embodiments the stable Young's modulus is stable at a range of from 0.1 GPa to 3 GPa at temperatures ranging from −55° C. to 150° C. measured at 0.07% strain before, during, and after the device is subjected to at least 500 thermal cycles. In some embodiments the stable Young's modulus is stable at a range of from 1 GPa to 2 GPa at temperatures ranging from −55° C. to 150° C. measured at 0.07% strain before, during, and after the device is subjected to at least 500 thermal cycles.

In some embodiments the stable Young's modulus is stable at a range of from 0.001 GPa to 5.5 GPa at temperatures ranging from −20° C. to 100° C. measured at 0.07% strain before, during, and after the device is subjected to at least 500 thermal cycles. In some embodiments the stable Young's modulus is stable at a range of from 0.001 GPa to 5.5 GPa at temperatures ranging from −10° C. to 80° C. measured at 0.07% strain before, during, and after the device is subjected to at least 500 thermal cycles. In some embodiments the stable Young's modulus is stable at a range of from 0.001 GPa to 5.5 GPa at temperatures ranging from −5° C. to 40° C. measured at 0.07% strain before, during, and after the device is subjected to at least 500 thermal cycles. In some embodiments the stable Young's modulus is stable at a range of from 0.001 GPa to 5.5 GPa at temperatures ranging from 10° C. to 20° C. measured at 0.07% strain before, during, and after the device is subjected to at least 500 thermal cycles.

In some embodiments the stable Young's modulus is stable at a range of from 0.001 GPa to 5.5 GPa at temperatures ranging from −55° C. to 150° C. measured at 0.07% strain before, during, and after the device is subjected to at least 500 thermal cycles. In some embodiments the stable Young's modulus is stable at a range of from 0.001 GPa to 5.5 GPa at temperatures ranging from −55° C. to 150° C. measured at 0.07% strain before, during, and after the device is subjected to at least 1000 thermal cycles. In some embodiments the stable Young's modulus is stable at a range of from 0.001 GPa to 5.5 GPa at temperatures ranging from −55° C. to 150° C. measured at 0.07% strain before, during, and after the device is subjected to at least 10,000 thermal cycles. In some embodiments the stable Young's modulus is stable at a range of from 0.001 GPa to 5.5 GPa at temperatures ranging from −55° C. to 150° C. measured at 0.07% strain before, during, and after the device is subjected to at least 25,000 thermal cycles. In some embodiments the stable Young's modulus is stable at a range of from 0.001 GPa to 5.5 GPa at temperatures ranging from −55° C. to 150° C. measured at 0.07% strain before, during, and after the device is subjected to at least 50,000 thermal cycles. In some embodiments the stable Young's modulus is stable at a range of from 0.001 GPa to 5.5 GPa at temperatures ranging from −55° C. to 150° C. measured at 0.07% strain before, during, and after the device is subjected to at least 100,000 thermal cycles.

In some embodiments, the at least one encapsulant has a stable yield strain as defined herein.

In some embodiments, the stable yield strain is maintained before, during, and after the device is subjected to at least 500 thermal cycles. In some embodiments, the stable yield strain is maintained before, during, and after the device is subjected to at least 1000 thermal cycles. In some embodiments, the stable yield strain is maintained before, during, and after the device is subjected to at least 10,000 thermal cycles. In some embodiments, the stable yield strain is maintained before, during, and after the device is subjected to at least 25,000 thermal cycles. In some embodiments, the stable yield strain is maintained before, during, and after the device is subjected to at least 50,000 thermal cycles. In some embodiments, the stable yield strain is maintained before, during, and after the device is subjected to at least 100,000 thermal cycles.

In some embodiments, at least one of the stable Young's modulus, the stable yield strain, or any combination thereof is maintained before, during, and after the device is subjected to from 500 to 1000 thermal cycles. In some embodiments, at least one of the stable Young's modulus, the stable yield strain, or any combination thereof is maintained before, during, and after the device is subjected to from 500 to 900 thermal cycles. In some embodiments, at least one of the stable Young's modulus, the stable yield strain, or any combination thereof is maintained before, during, and after the device is subjected to from 500 to 800 thermal cycles. In some embodiments, at least one of the stable Young's modulus, the stable yield strain, or any combination thereof is maintained before, during, and after the device is subjected to from 500 to 700 thermal cycles. In some embodiments, at least one of the stable Young's modulus, the stable yield strain, or any combination thereof is maintained before, during, and after the device is subjected to from to 600 thermal cycles.

In some embodiments, at least one of the stable Young's modulus, the stable yield strain, or any combination thereof is maintained before, during, and after the device is subjected to from 600 to 1000 thermal cycles. In some embodiments, at least one of the stable Young's modulus, the stable yield strain, or any combination thereof is maintained before, during, and after the device is subjected to from 700 to 1000 thermal cycles. In some embodiments, at least one of the stable Young's modulus, the stable yield strain, or any combination thereof is maintained before, during, and after the device is subjected to from 800 to 1000 thermal cycles. In some embodiments, at least one of the stable Young's modulus, the stable yield strain, or any combination thereof is maintained before, during, and after the device is subjected to from 900 to 1000 thermal cycles.

In some embodiments, at least one of the stable Young's modulus, the stable yield strain, or any combination thereof is maintained before, during, and after the device is subjected to from 600 to 900 thermal cycles. In some embodiments, at least one of the stable Young's modulus, the stable yield strain, or any combination thereof is maintained before, during, and after the device is subjected to from 700 to 800 thermal cycles.

In some embodiments, the at least one encapsulant remains in contact with the capacitor, without cracking, splitting, or pulling away from the capacitor, over any number of thermal cycles delineated herein.

In some embodiments, the stable yield strain exceeds 2.5% at a yield stress exceeding 30 MPa at −55° C. In some embodiments, the stable yield strain exceeds 5% at a yield stress exceeding 30 MPa at −55° C. In some embodiments, the stable yield strain exceeds 10% at a yield stress exceeding 30 MPa at −55° C. In some embodiments, the stable yield strain exceeds 25% at a yield stress exceeding 30 MPa at −55° C. In some embodiments, the stable yield strain exceeds 50% at a yield stress exceeding 30 MPa at −55° C. In some embodiments, the stable yield strain exceeds 75% at a yield stress exceeding 30 MPa at −55° C. In some embodiments, the stable yield strain exceeds 100% at a yield stress exceeding 30 MPa at −55° C.

In some embodiments, the stable yield strain exceeds 2.5% at a yield stress exceeding 100 MPa at −55° C. In some embodiments, the stable yield strain exceeds 2.5% at a yield stress exceeding 500 MPa at −55° C. In some embodiments, the stable yield strain exceeds 2.5% at a yield stress exceeding 1000 MPa at −55° C. In some embodiments, the stable yield strain exceeds 2.5% at a yield stress exceeding 2500 MPa at −55° C. In some embodiments, the stable yield strain exceeds 2.5% at a yield stress exceeding 5500 MPa at −55° C.

In some embodiments, the stable yield strain ranges from 2.5% to 100% at a yield stress ranging from 30 MPa to 5500 MPa at −55° C. In some embodiments, the stable yield strain ranges from 5% to 75% at a yield stress ranging from 30 MPa to 5500 MPa at −55° C. In some embodiments, the stable yield strain ranges from 10% to 50% at a yield stress ranging from 30 MPa to 5500 MPa at −55° C. In some embodiments, the stable yield strain ranges from 20% to 25% at a yield stress ranging from 30 MPa to 5500 MPa at −55° C.

In some embodiments, the stable yield strain ranges from 2.5% to 100% at a yield stress ranging from 50 MPa to 5000 MPa at −55° C. In some embodiments, the stable yield strain ranges from 2.5% to 100% at a yield stress ranging from 100 MPa to 1000 MPa at −55° C. In some embodiments, the stable yield strain ranges from 2.5% to 100% at a yield stress ranging from 250 MPa to 500 MPa at −55° C.

In some embodiments, the stable yield strain exceeds 3.5% at a yield stress exceeding 0.25 MPa at 150° C. In some embodiments, the stable yield strain exceeds 10% at a yield stress exceeding 0.25 MPa at 150° C. In some embodiments, the stable yield strain exceeds 25% at a yield stress exceeding 0.25 MPa at 150° C. In some embodiments, the stable yield strain exceeds 50% at a yield stress exceeding 0.25 MPa at 150° C. In some embodiments, the stable yield strain exceeds 75% at a yield stress exceeding 0.25 MPa at 150° C. In some embodiments, the stable yield strain exceeds 100% at a yield stress exceeding 0.25 MPa at 150° C.

In some embodiments, the stable yield strain exceeds 3.5% at a yield stress exceeding 1 MPa at 150° C. In some embodiments, the stable yield strain exceeds 3.5% at a yield stress exceeding 10 MPa at 150° C. In some embodiments, the stable yield strain exceeds 3.5% at a yield stress exceeding 50 MPa at 150° C. In some embodiments, the stable yield strain exceeds 3.5% at a yield stress exceeding 100 MPa at 150° C. In some embodiments, the stable yield strain exceeds 3.5% at a yield stress exceeding 1000 MPa at 150° C. In some embodiments, the stable yield strain exceeds 3.5% at a yield stress exceeding 5500 MPa at 150° C.

In some embodiments, the stable yield strain ranges from 3.5% to 100% at a yield stress ranging from 0.25 MPa to 5500 MPa at 150° C. In some embodiments, the stable yield strain ranges from 5% to 75% at a yield stress ranging from 0.25 MPa to 5500 MPa at 150° C. In some embodiments, the stable yield strain ranges from 10% to 50% at a yield stress ranging from 0.25 MPa to 5500 MPa at 150° C. In some embodiments, the stable yield strain ranges from 20% to 25% at a yield stress ranging from 0.25 MPa to MPa at 150° C.

In some embodiments, the stable yield strain ranges from 3.5% to 100% at a yield stress ranging from 0.25 MPa to 5500 MPa at 150° C. In some embodiments, the stable yield strain ranges from 3.5% to 100% at a yield stress ranging from 1 MPa to 5000 MPa at 150° C. In some embodiments, the stable yield strain ranges from 3.5% to 100% at a yield stress ranging from 10 MPa to 2000 MPa at 150° C. In some embodiments, the stable yield strain ranges from 3.5% to 100% at a yield stress ranging from 100 MPa to MPa at 150° C. In some embodiments, the stable yield strain ranges from 3.5% to 100% at a yield stress ranging from 200 MPa to 500 MPa at 150° C.

In some embodiments the at least one encapsulant has a crystallinity that can be determined by measuring crystallinity (e.g., by X-Ray diffraction or any other suitable measurement technique) of any exemplary device described herein. In some embodiments, the at least one encapsulant is predominantly amorphous (i.e., has limited crystallinity) over any number of thermal cycles described herein.

In some embodiments, the at least one encapsulant provides the device with a sufficient amount of electrical insulation, such that the device can withstand at least 500 V of electromotive force per millimeter of encapsulant thickness. In some embodiments, the at least one encapsulant provides the device with a sufficient amount of electrical insulation, such that the device can withstand at least 1000 V of electromotive force per millimeter of encapsulant thickness. In some embodiments, the at least one encapsulant provides the device with a sufficient amount of electrical insulation, such that the device can withstand at least 5000 V of electromotive force per millimeter of encapsulant thickness. In some embodiments, the at least one encapsulant provides the device with a sufficient amount of electrical insulation, such that the device can withstand at least 10,000 V of electromotive force per millimeter of encapsulant thickness.

In some embodiments, the at least one encapsulant provides the device with a sufficient amount of moisture resistance such that the device exhibits an insulation resistance (IR) of at least 1 Giga Ω·F tested according to IEC standard 60384.45 with a test time of less than or equal to 2 minutes. In some embodiments, the at least one encapsulant provides the device with a sufficient amount of moisture resistance such that the device exhibits an IR of at least 5 Giga Ω·F tested according to IEC standard 60384.45 with a test time of less than or equal to 2 minutes. In some embodiments, the at least one encapsulant provides the device with a sufficient amount of moisture resistance such that the device exhibits an IR of at least 10 Giga Ω·F tested according to IEC standard 60384.45 with a test time of less than or equal to 2 minutes. In some embodiments, the at least one encapsulant provides the device with a sufficient amount of moisture resistance such that the device exhibits an IR of at least 20 Giga Ω·F tested according to IEC standard 60384.45 with a test time of less than or equal to 2 minutes. In some embodiments, the at least one encapsulant provides the device with a sufficient amount of moisture resistance such that the device exhibits an IR of at least 50 Giga Ω·F tested according to IEC standard 60384.45 with a test time of less than or equal to 2 minutes.

Some embodiments of the present disclosure relate to a method of manufacturing a device described herein. Some embodiments of the method of manufacturing the device comprise applying at least one encapsulant to at least one portion of a capacitor, so as to at least partially encapsulate the capacitor. Some embodiments of the method of manufacturing the device comprise applying at least one encapsulant to at least one portion of a capacitor, so as to partially encapsulate the capacitor. Some embodiments of the method of manufacturing the device comprise applying at least one encapsulant to at least one portion of a capacitor, so as to fully encapsulate the capacitor.

In some embodiments, the applying step comprises spray coating a solution comprising the at least one encapsulant on at least a portion of the capacitor, so as to partially encapsulate the capacitor. In some embodiments, the applying step comprises spray coating at least one of: the first end of the capacitor, a second end of the capacitor, or any combination thereof.

In some embodiments, the spray coating coats the at least one encapsulant into one or more voids on the capacitor. In some embodiments the one or more voids that are coated are present on the first end of the capacitor, the second end of the capacitor, or any combination thereof.

In some embodiments, the applying step comprises dipping at least a portion of the capacitor into a solution comprising the at least one encapsulant, so as to partially encapsulate the capacitor.

In some embodiments, the applying step comprises both spray coating and dipping.

In some embodiments, the applying step includes any suitable step (or combination of steps) of applying at least one encapsulant, as would be understood by one skilled in the art.

In some embodiments, the at least one encapsulant dissolves in the solution.

In some embodiments, the solution comprises at least one solvent chosen from: N-Methyl-2-Pyrrolidone; N, N-dimethylacetamide; N, N-dimethylformamide; N, N-dimethylacetam ide; hexamethylphosphoramide; tetramethylurea; triethylphosphate trimethylphosphate, any combination, or mixture thereof. The aforementioned list of solvents is not intended to be limiting and may include any solvent that is capable of dissolving at least one encapsulant described herein, as would be understood by one skilled in the art.

In some embodiments, the capacitor is a metallized film capacitor. In some embodiments of the metallized film capacitor, the solution comprises a sufficient amount of the at least one solvent described herein, so as not to corrode a less than 1 μm thick aluminum or zinc deposit on the metallized film capacitor described herein. In some embodiments of the metallized film capacitor, the solution comprises a sufficient amount of the at least one solvent described herein, so as not to corrode a less than 0.5 μm thick aluminum or zinc deposit on the metallized film capacitor described herein. In some embodiments of the metallized film capacitor, the solution comprises a sufficient amount of the at least one solvent described herein, so as not to corrode a less than 0.25 μm thick aluminum or zinc deposit on the metallized film capacitor described herein. In some embodiments of the metallized film capacitor, the solution comprises a sufficient amount of the at least one solvent described herein, so as not to corrode a less than 0.1 μm thick aluminum or zinc deposit on the metallized film capacitor described herein.

In some embodiments, the method comprises evaporating the at least one solvent.

In some embodiments, the applying step comprises injection molding the at least one encapsulant over the capacitor, so as to fully encapsulate the capacitor. In some embodiments, the injection molding is performed after at least one of: spray coating, dipping, or any combination thereof. In some embodiments, the injection molding comprises overmolding the at least one encapsulant over the capacitor, so as to fully encapsulate the capacitor. In some embodiments, the overmolding is performed after at least one of: spray coating, dipping, or any combination thereof.

Some embodiments of the present disclosure relate to methods of using a device described herein.

In some embodiments, the method includes subjecting the device described herein to at least 500 thermal cycles. In some embodiments, the method includes subjecting the device described herein to at least 1,000 thermal cycles. In some embodiments, the method includes subjecting the device described herein to at least 5,000 thermal cycles. In some embodiments, the method includes subjecting the device described herein to at least 10,000 thermal cycles. In some embodiments, the method includes subjecting the device described herein to at least 25,000 thermal cycles. In some embodiments, the method includes subjecting the device described herein to at least 50,000 thermal cycles.

In some embodiments, the method includes subjecting the device described herein to at least 100,000 thermal cycles.

In some embodiments, the method includes subjecting the device described herein to 500 to 1000 thermal cycles. In some embodiments, the method includes subjecting the device described herein to 500 to 900 thermal cycles. In some embodiments, the method includes subjecting the device described herein to 500 to 800 thermal cycles. In some embodiments, the method includes subjecting the device described herein to 500 to 700 thermal cycles. In some embodiments, the method includes subjecting the device described herein to 500 to 600 thermal cycles.

In some embodiments, the method includes subjecting the device described herein to 600 to 1000 thermal cycles. In some embodiments, the method includes subjecting the device described herein to 700 to 1000 thermal cycles. In some embodiments, the method includes subjecting the device described herein to 800 to 1000 thermal cycles. In some embodiments, the method includes subjecting the device described herein to 900 to 1000 thermal cycles.

In some embodiments, the method includes subjecting the device described herein to 600 to 900 thermal cycles. In some embodiments, the method includes subjecting the device described herein to 700 to 800 thermal cycles.

### EXAMPLES

The following are examples of certain embodiments of the present disclosure. The following examples are illustrative and are not intended to be limiting.

In Examples 1-3, the following non-limiting exemplary polymers of the present disclosure were tested: (I) Arkema™ Kynar® 705 Resin; (II) Arkema™ Kynar Flex® 3120-10; and (III) Arkema™ Kynar Flex® 3030-10 Resin.

### Example 1: Dynamic Mechanical Analysis (DMA) of Exemplary Polymers (I) to (III)

DMA data on rectangular samples of exemplary polymers (I) to (III) were collected in single cantilever mode using a TA Instruments Q800 DMA. Samples were analyzed between −80° and 150° C., using a heating rate of 3° C./min, a frequency of 1 Hz and an oscillatory amplitude of 20 μm.

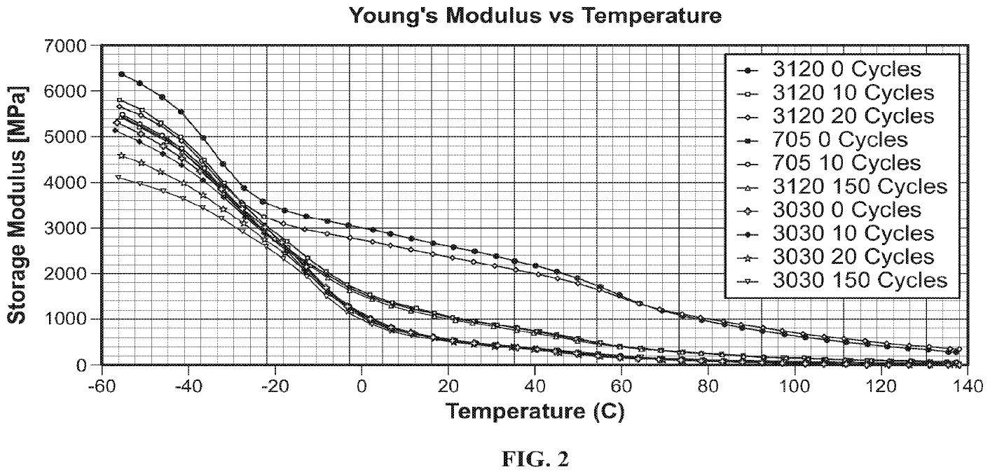

Results are shown in FIG. 2.

### Example 2: Differential Scanning Calorimetry (DSC) Measurements of Exemplary Polymers (I) to (III)

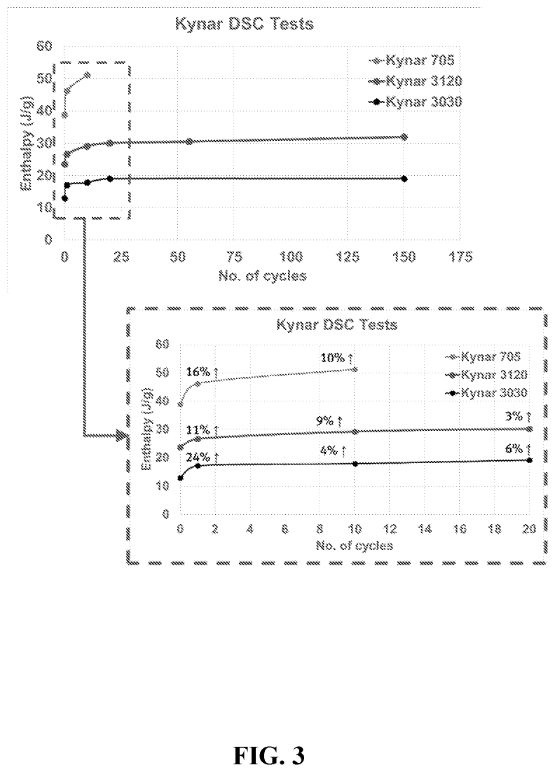

DSC data of exemplary polymers (I) to (III) were collected using a TA Instruments Discovery DSC between −70° C. and 200° C., using a heating rate of 3° C./m in. Results are shown in FIG. 3.

### Example 3: Stress-Strain (“Tensile”) Testing of Exemplary Polymers (II) and (III)

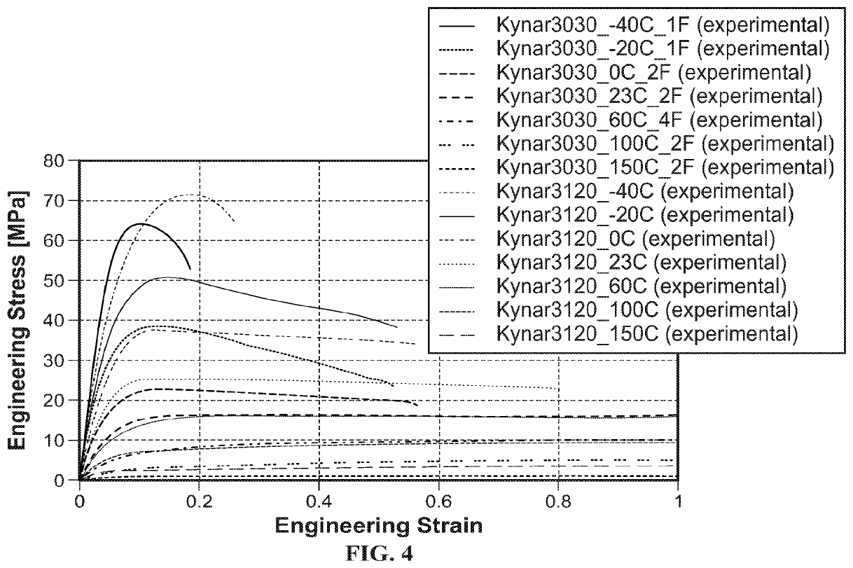

Exemplary polymers (II) and (III) were tensile tested in accordance with ASTM D638. Samples of the exemplary polymers were formed into an ASTM D638 Type V dog-bone geometry. The geometrically-formed samples were also allowed to stabilize at room temperature for 5 minutes. Properties of the geometrically-formed samples were determined at the following tensile test temperatures: −40° C., −20° C., 0° C., 23° C., 60° C., 100° C., and 150° C. The tensile test was performed with a constant strain rate of 3.8 mm/mm/sec. Results are shown in FIG. 4.

### Example 4: Non-Limiting Characteristics of a 1-20 μF Encapsulated Film Capacitor

A 20 μF metalized film capacitor (“the capacitor”) was constructed per the teachings of Example 4 of U.S. Pat. No. 9,384,895. The film capacitor was determined to have the following attributes:

Film: a densified ePTFE film having a nominal 4 μm thickness.

Nominal un-encapsulated capacitor dimensions: 27 mm width, 34 mm diameter, 30 mm height

Capacitance: The capacitor was wound to obtain a nominal 20 μF value.

Pre-encapsulation preparation procedure: The following pre-encapsulation preparation procedure was performed: Two metal terminals were attached to each end of the capacitor at the end-spray. The capacitor was subjected to a “grind and sand” treatment (e.g., using a dremel tool, sandpaper, or other friction-based treatment), to remove weld spatter from upper and lower terminations and to remove any lips, overhangs or sharp edges in the end-spray/termination weld area. The connection interfaces of the terminations were masked. Each termination/end spray area was sand-blasted as needed to remove sharp edges.

End-spray coating: A solution of 40% by weight PVDF copolymer (Arkema Kynar Flex® 3030-10) was dissolved in NMP (N-methyl-pyrrolidone). 40 grams of the PVDF copolymer was poured into a flask along with 60 grams of the NMP. Using a stir plate and bar, the flask was covered and mixed at room temperature until all PVDF copolymer was dissolved in solution (the dissolution took less than 24 hours). A nominal 0.1 mm thickness of the coating of the copolymer solution was applied. The coating of the copolymer solution covered the end-spray on each end of the capacitor and around the edges of the terminations, such that the end spray and the termination/end spray weld spot were coated. The coating was cured for minimum of 72 hours at room temperature.

Injection molding: The capacitor was overmolded using molding technology where the bare capacitor was mounted concentrically with a cylindrical molding cavity at the terminal points with a nominal 1 mm clearance around the rest of the capacitor. The electrical connection ends of the terminals were prevented from being covered by polymer during molding. Mold vents and flow ports were prepared such that air was purged from the cavity during molding and any pressure from the polymer flow was distributed uniformly around a circumference of the capacitor. With the capacitor installed in the mold cavity a mold was preheated until the mold reached a uniform nominal temperature of 150° C. An injection molding machine was used such that the polymer (Arkema Kynar Flex® 3030-10) flowed from its injection nozzle/port at a nominal temperature of 200° C. The injection molding machine was purged as needed to clear any air. With the mold at 150° C., polymer was injected into the mold's injection port at a rate of 1.5 to 3 cc/second until the polymer completely filled the cavity. The mold temperature was maintained at 150° C. for a minimum of 10 minutes then allowed to cool to room temperature. The molded capacitor was removed from the mold and residual polymer was trimmed as needed so the encapsulated shape matched the cylindrical shape of the capacitor.

The following measurements were made.

Temperature cycling testing for encapsulation integrity: Encapsulated devices were evaluated for temperature cycling per JEDEC Standard JESD22-A104C for single chamber temperature cycling using test condition H, soak mode 4 and a cycle rate >0.1 cycles/hour for a total of 1000 cycles. Under visual inspection without magnification, there were no visible cracks in the coating/packaging.

Humidity exposure testing for encapsulation integrity: The capacitor terminals were protected from moisture exposure. The device comprising the capacitor was exposed per MIL-STD-202G Method 103 Test Condition C. Immediately after exposure, the device's insulation resistance (“IR”) was measured per IEC Standard 60384-1 Section 4.5 Test A. Per this measurement, the device maintained an insulation resistance greater than 20 Giga Ω·F.

Dielectric Withstand Voltage: A dielectric withstand voltage test was conducted per MIL-STD-202, Method 301 with settings of: 500 V DC for terminal-to-terminal test 1500 V AC at 60 Hz for terminal-to-case test. There was no visible or detectable evidence of damage, momentary or intermittent arcing, or other indication of electrical breakdown. Dwell current was 1≥mA.

### Example 5: Non-Limiting Characteristics of a 30 μF Encapsulated Film Capacitor

The same procedure as Example 4 was performed except that the capacitor was a 30 μF metalized film capacitor constructed with the following attributes:

Film: nominal 4 μm thick densified ePTFE.

Unpackaged capacitor dimensions: nominal 32 mm width, nominal 38 mm diameter, by 35 mm high

Capacitance: The capacitor was wound to obtain a nominal 30 μF value

The same measurements for temperature cycling testing for encapsulation integrity, humidity exposure testing for encapsulation integrity, and dielectric withstand voltage were made with the same results obtained.

### Example 6: Additional Non-Limiting Characteristics of a 1-20 μF Encapsulated Film Capacitor

The same procedure as Example 4 was performed except that the “end-spray coating” portion was omitted. The capacitor also had the same characteristics as that of Example 4.

The same measurements for temperature cycling testing for encapsulation integrity and dielectric withstand voltage were made with the same results obtained.

### Example 7: Additional Non-Limiting Characteristics of a 30 μF Encapsulated Film Capacitor

The same procedure as Example 5 was performed except that the “end-spray coating” portion was omitted. The capacitor also had the same characteristics as that of Example 5.

The same measurements for temperature cycling testing for encapsulation integrity and dielectric withstand voltage were made with the same results obtained.

Variations, modifications and alterations to embodiments of the present disclosure described above will make themselves apparent to those skilled in the art. All such variations, modifications, alterations and the like are intended to fall within the spirit and scope of the present disclosure, limited solely by the appended claims.

While several embodiments of the present disclosure have been described, it is understood that these embodiments are illustrative only, and not restrictive, and that many modifications may become apparent to those of ordinary skill in the art. For example, all dimensions discussed herein are provided as examples only, and are intended to be illustrative and not restrictive.

Any feature or element that is positively identified in this description may also be specifically excluded as a feature or element of an embodiment of the present as defined in the claims.

The disclosure described herein may be practiced in the absence of any element or elements, limitation or limitations, which is not specifically disclosed herein. Thus, for example, in each instance herein, any of the terms “comprising,” “consisting essentially of and “consisting of” may be replaced with either of the other two terms. The terms and expressions which have been employed are used as terms of description and not of limitation, and there is no intention in the use of such terms and expressions of excluding any equivalents of the features shown and described or portions thereof, but it is recognized that various modifications are possible within the scope of the disclosure.

1. A device comprising:
a capacitor; and
at least one encapsulant,
wherein the at least one encapsulant comprises at least one polymer;
wherein the at least one encapsulant at least partially encapsulates the capacitor;
wherein the at least one encapsulant has a stable Young's modulus,
and wherein the stable Young's modulus is a Young's modulus that ranges from 0.001 GPa to 5.5 GPa at temperatures ranging from −55° C. to 150° C. measured at 0.07% strain before, during, and after the device is subjected to at least 500 thermal cycles.

2. The device of claim 1, wherein the at least one encapsulant has a stable yield strain,
wherein the stable yield strain is a minimum maintained yield strain of the at least one encapsulant before, during, and after the device is subjected to at least 500 thermal cycles;
wherein the stable yield strain exceeds 2.5% at a yield stress exceeding 30 MPa at −55° C.; and
wherein the stable yield strain exceeds 3.5% at a yield stress exceeding 0.25 MPa at 150° C.

3. The device of claim 1, wherein the stable yield strain ranges from 2.5% to 100% at a yield stress ranging from 30 MPa to 5500 MPa at −55° C.

4. The device of claim 1, wherein the stable yield strain ranges from 3.5% to 100% at a yield stress ranging from 0.25 MPa to 5500 MPa at 150° C.

5. The device of claim 1, wherein at least one of the: stable Young's modulus or the stable yield strain is maintained before, during, and after the device is subjected to from 500 to 1000 thermal cycles.

6. The device of claim 1, wherein the at least one encapsulant has a thickness of from 0.05 mm to 20 mm.

7. The device of claim 1, wherein the capacitor is a film capacitor.

8. The device of claim 7, wherein the capacitor further comprises:
a first electrode;
a second electrode; and
at least one dielectric layer,
wherein the at least one dielectric layer is disposed between the first electrode of the capacitor and the second electrode of the capacitor.

9. The device of claim 7, wherein the capacitor further comprises:
a first end,
wherein the first electrode is at the first end of the capacitor;
a second end,
wherein the second electrode is at the second end of the capacitor;
a first dielectric layer,
wherein the first dielectric layer is disposed between the first electrode and the second electrode,
wherein the first electrode has an exposed surface opposite to the first dielectric layer; and
a second dielectric layer.

10. (canceled)

11. The device of claim 7, wherein the capacitor comprises a polytetrafluoroethylene (PTFE) film.

12. The device of claim 1, wherein the capacitor is chosen from: an electrolytic capacitor, a ceramic capacitor, a mica capacitor, or a paper capacitor.

13. The device of claim 1, wherein the at least one polymer of the at least one encapsulant comprises at least one thermoplastic elastomer (TPE).

14. The device of claim 13, wherein the at least one TPE comprises at least one polymer chosen from: at least one polystyrene (PS), at least one polyolefin (PO), at least one polyether imide (PEI), at least one polyurethane (PU), at least one polyester (PE), at least one polyamide (PA), or any combination thereof.

15. The device of claim 1, wherein the at least one polymer of the at least one encapsulant comprises at least one thermoset elastomer (TE).

16. The device of claim 15, wherein the at least one TE comprises at least one epoxy resin, at least one fluorosilicone rubber, or any combination, mixture or copolymer thereof.

17. The device of claim 1, wherein the at least one polymer of the at least one encapsulant is chosen from: at least one vinylidene fluoride homopolymer, at least one vinylidene fluoride copolymer, or any combination thereof.

18. (canceled)

19. The device of claim 1, wherein the capacitor is a stacked capacitor or a wound capacitor.

20. (canceled)

21. The device of claim 1, wherein the capacitor has a capacitance of 0.1 μF to 2000 μF.

22. (canceled)

23. The device of claim 1, wherein at least one dielectric layer has a thickness of 1 micron to 6 microns.

24. The device of claim 1, wherein the at least one encapsulant partially encapsulates the capacitor or the at least one encapsulant fully encapsulates the capacitor.

25. (canceled)

26. A method comprising:
applying at least one encapsulant to at least one portion of a capacitor, so as to at least partially encapsulate the capacitor, thereby forming a device comprising the capacitor and the at the least one encapsulant;
wherein the encapsulant at least partially encapsulates the capacitor;
wherein the at least one encapsulant comprises at least one polymer;
wherein the at least one encapsulant has a stable Young's modulus,
wherein the stable Young's modulus is a Young's modulus that ranges from 0.001 GPa to 5.5 GPa at temperatures from −55° C. to 150° C. measured at 0.07% strain before, during, and after the device is subjected to at least 500 thermal cycles.

27. The method of claim 26, wherein the at least one encapsulant has a stable yield strain,
wherein the stable yield strain is a minimum maintained yield strain of the at least one encapsulant before, during, and after the device is subjected to at least 500 thermal cycles;
wherein the stable yield strain exceeds 2.5% at a yield stress exceeding 30 MPa at −55° C.; and
wherein the stable yield strain exceeds 3.5% at a yield stress exceeding 0.25 MPa at 150° C.

28. The method of claim 26 or 27, wherein the applying step comprises spray coating a solution comprising the at least one encapsulant on at least a portion of the capacitor, so as to partially encapsulate the capacitor.

29. (canceled)

30. The method of claim 26, wherein the at least one encapsulant is applied to: a first end of the capacitor, a second end of the capacitor, or any combination thereof; or wherein the applying step comprises dipping at least a portion of the capacitor into a solution comprising the at least one encapsulant, so as to partially encapsulate the capacitor; or wherein the applying step comprises dipping at least a portion of the capacitor into a solution comprising the at least one encapsulant and spray coating a solution comprising the at least one encapsulant on at least a portion of the capacitor, so as to partially encapsulate the capacitor.

31.-32. (canceled)

33. The method of claim 28, wherein the solution comprises a solvent chosen from: N-Methyl-2-Pyrrolidone; N, N-dimethylacetamide; N, N-dimethylformamide; N, N-dimethylacetamide; hexamethylphosphoram ide; tetramethylurea; triethylphosphate trim ethylphosphate, or any combination thereof.

34. (canceled)

35. The method of claim 26, wherein the applying step comprises injection molding the at least one encapsulant over the capacitor, so as to fully encapsulate the capacitor; or wherein the at least one encapsulant has a thickness of 0.05 mm to 20 mm after the applying step.

36. (canceled)

37. A method comprising:
providing a device comprising:
a capacitor;
at least one encapsulant,
wherein the at least one encapsulant comprises at least one polymer;
wherein the at least one encapsulant at least partially encapsulates the capacitor;
subjecting the device to at least 500 thermal cycles;
wherein, before, during, and after the subjecting step, the device has a stable Young's modulus,
wherein the stable Young's modulus is a Young's modulus that ranges from 0.001 GPa to 5.5 GPa at temperatures from −55° C. to 150° C. measured at 0.07% strain.

38. The method of claim 37, wherein, after the subjecting step, the at least one encapsulant has a stable yield strain,
wherein the stable yield strain is a minimum maintained yield strain of the at least one encapsulant before, during, and after the subjecting step;
wherein the stable yield strain exceeds 2.5% at a yield stress exceeding 30 MPa at −55° C.; and
wherein the stable yield strain exceeds 3.5% at a yield stress exceeding 0.25 MPa at 150° C.

39. The method of claim 37, wherein the device is subjected to 500 to 1000 thermal cycles during the subjecting step.
